(19) United States
(12) Patent Application Publication
(10) Pub. No.: US 2016/0075038 A1
(43) Pub. Date: Mar. 17, 2016

(54) CUT BLOCKER

(71) Applicant: Sandra Kay Long, West Babylon, NY (US)

(72) Inventor: Sandra Kay Long, West Babylon, NY (US)

(21) Appl. No.: 14/487,006

(22) Filed: Sep. 15, 2014

(51) Int. Cl. B26B 13/24; B26B 29/04

(52) U.S. Cl. CPC B26B 13/24; B26B 29/04

(57) ABSTRACT

The Cut Blocker provides a device for attachment to a ring of a pair of scissors where the rings of the scissors meet to prevent complete closing of the scissors for purposes of preventing cuts for training hair stylists.

### FIELD OF THE INVENTION

The present invention pertains to the field of hair styling, and more specifically to the field of hair cutting scissors, and safety devices therefor.

### BACKGROUND OF THE INVENTION

The prior art has put forth several designs for hair cutting scissors and safety devices therefor. Among these are:

US Patent 2011/0035949 to Jon P. Fesler describes scissors including a stop on one blade located a specified distance from one end of the blade. The stop allows the user of the scissors to easily make repeated cuts of the same specified length by inserting a material into the opening between the blades until it hits the stop. Upon closing the blades a cut of the specified length is created. The stop is implemented as a notch in the blade of the scissors or as a separate part attached with pins to the blade allowing the user to position the moveable stop over different sets of pins to provide different distances from the end of the blade to the stop, so the user can select the length of the desired cut.

US Patent 2005/0005456 to Ta-Tieh Wang and Chien-Che Huang describes a blade shaft for scissors. The end face of the body is provided with a screw hole and positioning protrusion. The end face of the shaft ring body is provided with a corresponding slot for a screw rod from the inner edge of the ring body passing through a spring and is locked to the screw hole of the body, forming into a controlling buffer when the shaft ring body rotates. By means of the rod element of the shaft body, the ring face of the shaft ring body is rotatable to an appropriate angle. By means of the protrusion and the recess, the blade is positioned at an open angle for hair cutting.

U.S. Pat. No. 5,499,454 to Dorothy G. Compton describes buttonhole scissors comprising a first blade having a blunt distal end and an inner flat surface between a tapered cutting edge and an outer edge. A second blade contains a pointed distal end and an inner flat surface between a tapered cutting edge and an outer edge. These blades are slidable over each other with each of the inner flat surfaces in close cutting engagement. A pair of handles for the blades are pivotally connected. An intermediate portion of each blade is provided with a notch arranged between the cutting edge and the pivot point that cooperates to form a noncutting area which receives cloth not to be cut. An adjustable setting means, that is mounted through one handle and contacts the other handle, is capable of adjustment to limit the movement of the blades relative to each other.

U.S. Pat. No. 6,928,740 to Wen-Ya Yeh describes a buffering member for scissors comprising a buffering member attachable to a one ring of a pair of scissors to prevent the ring portions from bumping against each other thereby reducing discomfort to the user's fingers, and wherein the operation of the scissors is avoided.

None of these prior art references describe the present invention.

### SUMMARY OF THE INVENTION

It is an object of the present invention to provide a safety block that adheres to a ring of any pair of scissors and prevents the scissors' blades from fully closing at their tips.

### BRIEF DESCRIPTION OF THE DRAWINGS

FIG. 1 is an illustrative side view of the cut blocker of the present invention.

FIG. 2 is an illustrative side view of a pair of scissors having a stopper between the rings of the scissors.

FIG. 3 is an illustrative side view showing an open pair of scissors with the present invention placed over an existing stopper preventing the scissor tips from fully closing and causing finger nicks and cuts.

FIG. 4 is an illustrative side view showing the present invention mounted to a stopper and preventing complete closing of the blades of the scissors.

FIG. 5 contains prototypical close up views showing the present invention in various colors.

### DETAILED DESCRIPTION OF THE INVENTION

Hairstylists are creative professionals whose work requires skill learned through practice, instruction, and a certain amount of trial and error. By the time they begin receiving regular clients, hairstylists have practiced on family and friends and made their fair share of mistakes. A hairstylist's main tool is a pair of scissors, so it stands to reason that they fumble with them while learning to use their scissors properly. Accidents involving scissors are quite painful, unsanitary and unpleasant enough to dissuade potential clients. While a seasoned professional is less likely to cut themselves than a novice stylist, mistakes do happen. A hairstylist's reputation relies on trust built with clients and much of a hairstylist's clientele is made up of regular customers. Most clientele want their hair needs taken care of by someone on whom they can rely, a professional who works in a sanitary, welcoming and efficient environment. One painful and unpleasant mistake by a hairstylist with a pair of scissors is enough to scare a customer away for good. Hairstylists will welcome a simple and unobtrusive fix that prevents such scissor related injuries.

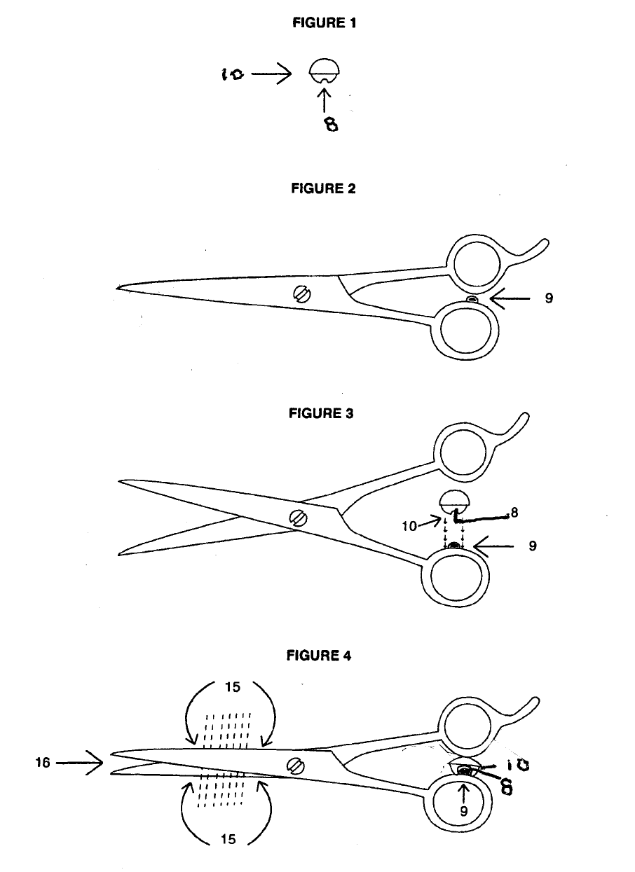

Please refer to the figures. The Cut Blocker 10, shown in FIG. 1, attaches to the stopper 9 of a pair of scissors having a stopper. The Cut Blocker comprises a flexible, ovoid button having an indentation 8 for receiving the stopper 9 of the scissors. For scissors without a stopper, the Cut Blocker 10 can be glued directly to the ring of the scissors where the rings of the scissors meet. A pair of scissors having a stopper is shown in FIG. 2.

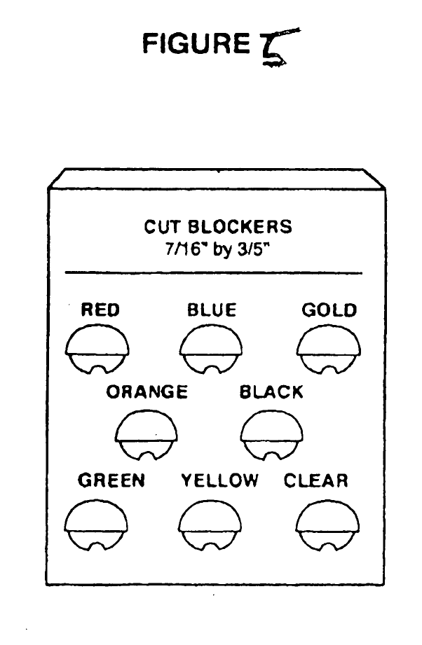

FIG. 3 shows the placement of the Cut Blocker 10 onto the stopper 9 of a pair of scissors.

When the Cut Blocker 10 is mounted onto the stopper 9 of a pair of scissors, the scissors are preventing from completely closing, thereby preventing cuts to the aspiring stylist. With the Cut Blocker in place, the area of cut 15 is shown in FIG. 4.

The Cut Blocker is available in various colors, as shown in FIG. 5 for easy identification of one's scissors.

The present invention, hereinafter referred to as a Cut Blocker, is an aid for hair stylists and cosmetology students which attaches to scissors to prevent a stylist using the scissors from accidentally cutting themselves. A Cut Blocker is an unobtrusive attachment that fits on the stopper of a pair of scissors, preventing the scissors from fully closing. A Cut Blocker protects those individuals who regularly use scissors, whether a veteran stylist or a novice user, without upsetting their rhythm of work. The present invention functions effectively for hairstylists who cut hair according to professional etiquette which often requires them to place their fingers and palm near the tip of their scissors. For budding hairstylists, a Cut Blocker provides a feeling of security that allows them to focus on other important aspects of their work such as angles, degrees and length of hair they're cutting.

Small in size and round in shape, a Cut Blocker is fabricated from rubber or acrylic, comes in various colors and sizes and is easily attachable to a pair of scissors a stylist prefers to use. The present invention is applicable to any scissor with a stopper, regardless the scissor's size, style or material. Each Cut Blocker measures approximately seven sixteenths of an inch in height and three fifths of an inch in diameter. A Cut Blocker snaps on and off a scissor handle stopper for secure attachment and easy removal. For scissors without stoppers or scissors containing flat wide shanks, a Cut Blocker attaches and adheres to the scissors using a small amount of bonding adhesive. Using a Cut Blocker requires no prior measurement of one's scissors for fitting purposes. However, it does require consideration of placement if no stopper is present. Cut Blockers are interchangeable, usable on different scissors and shareable among professionals. After snapping it on a pair of scissors, the present invention works immediately and leaves behind no excess material when removed.

Cut Blockers also function as teaching aids, allowing students or novice stylists to concentrate entirely on the task at hand while learning the finer points of their craft. Using a Cut Blocker forces a stylist to consistently practice a proper cutting technique. With the Cut Blocker attached and their hand held above the scissors holding their client's hair between their fingers, a hairstylist can cut only to the second joint of their middle finger. When the hairstylist learns this cutting technique thoroughly and develops a lot of confidence, he or she may remove the Cut Blocker and trim away without fear of closing the scissors too far. If preferred, the hairstylist may continue to keep the Cut Blocker on their scissors as a buffer against distractions, momentary carelessness or a simple mistake.

The present invention is immediately usable, providing a great safety tool for both new and seasoned hair professionals. It's great for any hairstylist, whether they're busy learning their craft or busy chatting with a customer they've seen regularly for years. Durably constructed, the Cut Blocker will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A safety block device that adheres to a ring of a pair of scissors to prevent the scissors' blades from fully closing at their tips, comprising a flexible ovoid button for attachment to one ring of a pair of scissors where the rings of the scissors meet.

2. The safety block device of claim 1 wherein the flexible ovoid button further comprises an indentation for receiving a stopper of a pair of scissors having a stopper, wherein the indentation is capable of being snapped into place on the stopper.

3. The safety block device of claim 1 wherein the flexible ovoid button is capable of being directly glued to the ring of the scissors wherein the rings of the scissors meet.

4. The safety block device of claim 2, wherein the device measures approximately seven sixteenths of an inch in height and three fifths of an inch in diameter.

5. The safety block device of claim 2, wherein the device is available in a variety of colors for identification.
